(19) United States
(12) Patent Application Publication
(10) Pub. No.: US 2008/0164688 A1
(43) Pub. Date: Jul. 10, 2008

(54) Magnetic writing mat and method of using same on police cars and other vehicles

(76) Inventor: Jeramie D. Huff, Fruitland, ID (US)

Correspondence Address: PEDERSEN & COMPANY, PLLC, P.O. BOX 2666, BOISE, ID, 83701, US

(21) Appl. No.: 11/652,176

(22) Filed: Jan. 10, 2007

(51) Int. Cl. B42D 3/18; B42D 17/00

(52) U.S. Cl. 281/45; 281/44

(57) ABSTRACT

A writing mat comprises a writing surface which may be magnetically secured to a ferrous metallic surface of a vehicle and may be left in said secured position while the vehicle is in motion. Preferably, that vehicle surface is a generally horizontal surface so that the writing mat is held and used substantially horizontally. Said writing mat may have disposed, upon its upper surface, an engaging and retaining means for securing papers thereon, and a recessed area for placement and containment of small items. Preferred embodiments are flexible, for generally matching the contour of the vehicle surface upon which it is placed and for easier removal by “peeling” or otherwise pulling the mat off of the vehicle.

### BACKGROUND OF THE INVENTION

1. Field of the Invention

The present invention relates generally to portable devices used to engage and retain papers and comprising a surface for writing upon said papers. More specifically, the invention relates to a self-contained, portable device designed for the purpose described above that may be magnetically attached to a vehicle surface, such as a hood or trunk lid, and that may be left in the desired position upon the vehicle even while the vehicle is in motion.

The use of the invented magnetic writing mat will be recognized as extremely practical by those individuals who find it necessary, due to the nature of their employment, to move about from place to place in a vehicle, and to fill out or refer to paperwork during the frequent stops they must accomplish. Said persons would include, but are not limited to law enforcement officers, realtors, game wardens, surveyors, building inspectors, or construction estimators and contractors.

2. Related Art

Several magnetic clip boards and folios, including for outdoor use, are described in the patent literature, as follows:

U.S. Pat. No. 4,588,209, Zebrowski, etal., discloses a folio device that is hinged near its middle and that has magnetic strips on the back.

U.S. Pat. No. 5,904,373, Krapf, discloses a magnetic jacket designed for containing papers.

U.S. Pat. No. 5,503,891, Marshall, etal., discloses a magnetic display mat designed primarily for receiving and retaining magnetic display symbols.

U.S. Pat. No. 5,590,910, Meth, discloses a covered clipboard for use in inclement weather. Meth provides a box-like cover with an open end for entry by the writer's hand.

U.S. Pat. No. 3,951,486, Tracy, discloses an organizer file and briefcase-desk combination for vehicles. The organizer file, which has pockets, is hung over the seat back of a vehicle. The briefcase hangs from hooks on the organizer file unit.

Magnetic signs are used on vehicle exteriors, but these are flat panels without other structure. Magnetic signs are provided only on generally vertical surfaces, such as the vehicle doors and vertical fenders, so that they are easily visible from a distance to attract attention to the information thereon advertising a company or business.

till, the inventor believes that there is a need for a writing mat device for people who work mainly from their vehicles and who write on or handle documents near, but outside, their vehicles. The inventor believes that there is also a need for such a system that comprises a loose item containment system.

### SUMMARY OF THE INVENTION

The present invention comprises a writing mat device providing a surface upon which papers may be placed and retained for reading, writing upon, or other purposes, wherein the device is adapted to removably adhere to an exterior panel of a vehicle. The present invention may comprise using said device on the exterior of a vehicle, wherein the device may be quickly deployed to a secure position on a generally horizontal portion of the vehicle, conveniently used with little or no manipulation of moving parts, and then conveniently removed from the vehicle exterior for storage inside the vehicle interior or trunk. Preferably, the device also comprises a containment system for holding loose objects, such as keys, pens, or items that are being confiscated, examined, labeled, or logged into a database by the user of the device.

The invented writing mat device is preferably designed to be magnetically secured to a relatively horizontal exterior surface of a vehicle, such as, but not limited to, a hood, trunk lid, or roof, so that a user may write tickets, record confiscated items, make notes, sign documents, or do other paperwork while standing beside or otherwise near the outside of his/her vehicle. Optionally, the device may be left in this position on the exterior of the vehicle even while the vehicle is in motion, remaining in place for the next time the user stops his/her vehicle and gets out of the vehicle to do more paperwork for whatever reason. Then, after a day's work is done, the user may remove the writing mat and store it or take it home, for example. To remove the writing mat from the vehicle surface, the user may grasp an edge of the writing mat, pull on the paper holding system (such as a clip), and/or may pull on other structure or handles (not shown) that may optionally be provided.

While the device may be of various shapes and thickness, it is preferred that the main body of the device is a panel and said panel is preferably a thin, and at least slightly flexible, sheet or layered sheets of material. The preferred panel has a top planar surface that comprises a writing surface adapted for receiving a paper(s) and for allowing the user to write upon said paper(s). Thus, preferably, the top planar surface, or at least a portion of it, is firm and smooth as commonly understood by the term “writing surface.” The bottom surface of the panel preferably comprises a magnetic material for adhering to a metal panel/portion of a vehicle. The panel of the writing mat may be a one or multiple layers, a composite material, a single layer, or one or more layers that have a thin outer coating such as a waterproof sheath, for example. The panel of the writing mat may comprise a lower magnetic layer and a firm upper rubber or vinyl layer, which are adhesively or otherwise bonded permanently to one another.

Various means for engaging and retaining papers on the device may be used, with the preferred being a spring-loaded clasping structure disposed upon the upper surface of the panel. Thus, the term “clip board” may be used to describe the preferred embodiments, but the invention may comprise various systems for retaining paper(s) from flying away or falling off of the device, including a clip, a spring, or any biasing or resilient system for holding paper(s) on the device, but also paper retaining systems that do not include a spring-biased member. For example, a resilient plastic member may overlay a portion of the main panel of the device, so that the paper(s) may be slid partially under the plastic member. Or, for example, corner holders may be provided into/under which the paper corners may be slid. Or, a moveable magnet may be provided that may be placed over a portion of the paper to cooperate with the other magnetic material of the device to hold the paper in-between. Therefore, the device does not require use of a traditional clip board spring-biased clip, but such a clip is preferred in many embodiments, as it allows great flexibility in paper size, placement, and removal.

Also, upon and within the upper surface, there may be provided a system for retaining or containing small “pocket” items or other items that the user wishes to prevent from rolling off of the vehicle. These items could comprise, but are not limited to, items that are confiscated by a law enforcement officer during an arrest, such as drugs and drug paraphernalia, and/or keys, money, or other small items. The preferred system for retaining or containing the loose items comprises a recess in the panel of the writing mat, wherein the recess forms a lower surface surrounded with walls that serve to retain the loose items within the recessed area. Thus, the items may rest in the recess, in close proximity to the paperwork which may need to be completed regarding said items and with reduced chance of rolling off of the vehicle.

The materials of the invented device are preferably lightweight and waterproof, such as plastic and rubber compounds, which are flexible and resilient enough to conform to the slightly-curved surfaces of a vehicle, and preferably suitably strong enough to permit the device to remain upon the vehicle surface while the vehicle is in motion. The materials and construction of the invented device are preferably such that they do not scratch, gouge, or otherwise damage the vehicle surfaces, even after repeated laying-out, use, and removal of the device.

The invention may include the method of using the preferred embodiments of the apparatus, by placing a writing mat on an exterior surface of a vehicle so that it adheres to the exterior surface by means comprising or consisting of magnetism. The method may include retaining paper(s) on a portion of the writing mat so that the user may write or mark the papers. The method may include retaining object(s), such as pocket items, on a portion of the apparatus, preferably by providing a recess in the apparatus that holds the object(s). The method may include the apparatus being “pealed” off of the vehicle surface and/or rolled up for compact storage. The method allows a user to control papers and objects and to have a comfortable space for writing, rather than writing on paper laid directly on the vehicle surface and rather than trying to balance papers or objects on another surface such as a vehicle bumper, a curb, a fence, or even a sidewalk.

The design of the preferred embodiments is especially effective for a law enforcement officer who has stopped a violator, as it permits the officer to have his hands free and unencumbered should the need arise for sudden action. It also permits the officer to step away from the paperwork and/or confiscated items, without them blowing or rolling away. It also assists the officer to do his paperwork in a professional-looking manner, at a device that, in effect, becomes his exterior vehicle desk.

The design of the preferred embodiments also may be especially effective for a realtor, contractor, or other professional who drives to a location to view, discuss, or negotiate regarding a building or piece of land. The professional may find it comfortable and convenient to conduct these steps while standing at the exterior of the vehicle, talking to a client or customer and making notes or recording numbers, rather than while sitting in the more confining and sometimes too-personal space of the interior of a vehicle.

### BRIEF DESCRIPTION OF THE DRAWINGS

FIG. 1 is a perspective view of a writing mat according to one embodiment of the present invention, wherein the writing mat is holding paper and other miscellaneous items.

FIG. 2 is a cross-sectional elevation view of the embodiment of FIG. 1, viewed along the line 2-2 in FIG. 1, and wherein the writing mat is installed on a vehicle surface.

FIG. 3 is a cross-sectional elevation view of the embodiment of FIG. 1, viewed along the line 3-3 in FIG. 1, wherein the writing mat is installed on a vehicle surface.

FIG. 4 is a top plan view of the embodiment of FIGS. 1-3.

FIG. 5 is a top plan view of an alternative embodiment holding a paper and featuring an alternative logo.

FIG. 6 is another embodiment of the invented writing mat wherein the main body of the mat comprises a single layer of material.

FIG. 7 is a cross-sectional elevation view of the embodiment of FIG. 6, viewed along the line 7-7 in FIG. 6.

FIG. 8 is a cross-sectional elevation view of the embodiment of FIG. 6, viewed along the line 8-8 in FIG. 6.

### DESCRIPTION OF THE PREFERRED EMBODIMENTS

Referring to the Figures, there are shown three, but not the only, embodiments of the invented writing mat device.

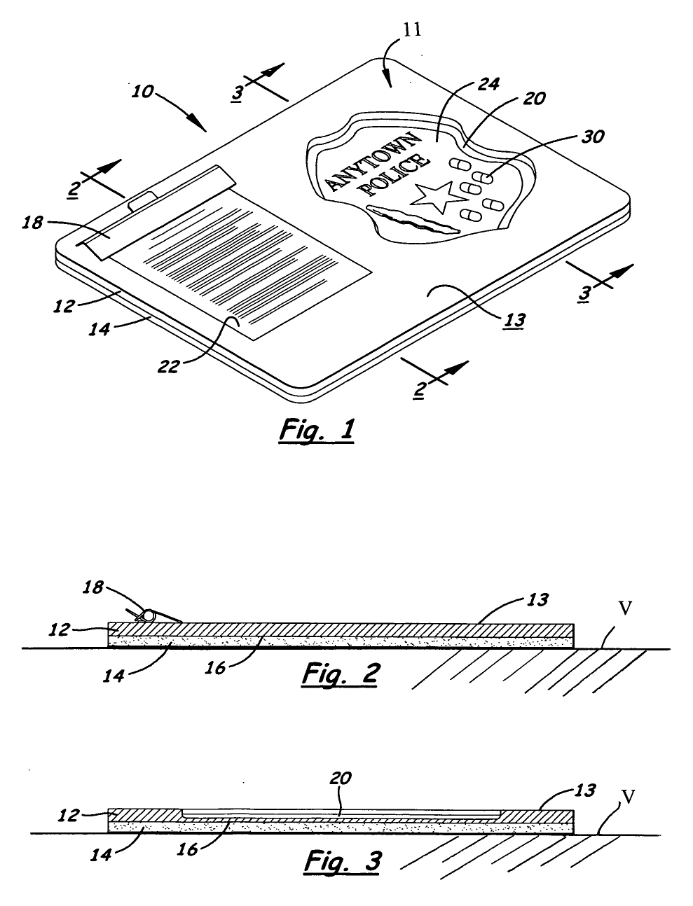

Referring now to FIGS. 1, 2 and 3, it may be observed that, the preferred writing mat device 10 is comprised of a main body or “panel” 11 that comprises an upper, resilient, flexible layer 12. Layer 12 may be a firm but slightly cushioning material that makes writing effective and comfortable. Permanently affixed upon upper surface 13 of upper layer 12 is spring-loaded clip 18 for the purpose of engaging and retaining papers 22. Clip 18 may be one of various clips available for conventional clip boards, for example, wherein the clip 18 is biased to trap paper between it and the panel 11 of the device 10, the clip 18 being manually moveable to a raised position to allow insertion of the paper(s) underneath the clip.

The panel 11 further comprises lower layer 14, adhesively bonded with adhesive 16 to upper layer 12 and constructed of a magnetically impregnated compound, which, when applied to a ferrous metallic surface, will securely and immovably adhere to that surface, and will, being flexible, assume the slightly curved shape inherent in most vehicle surfaces. Due to the strong magnetic attraction quality of lower layer 14, the invented device will remain in the installed position on the vehicle surface V when the vehicle is parked, in spite of wind, and even when the vehicle is in motion, preferably without any relative movement between the panel 11 and the vehicle V to prevent scratching of the vehicle surface V. Lower layer 14, when applied to a vehicle surface, will not damage the finish of the vehicle surface V.

Contained within, or extending through, upper layer 12 is recess 20, which is used to retain and prevent loss of small pocket items 30 such as coins and keys, or illegal items confiscated by a law enforcement officer during an arrest, for example. The use of the device 10 and associated recess 20 allows a law enforcement officer to have his or her hands instantly unencumbered, which is especially important in dealing with a violator. Further, use of the device 10 helps prevent the user from being distracted by a rolling, falling, or blowing-away paper or item, which helps a law enforcement officer focus on the important and potentially dangerous matters at hand.

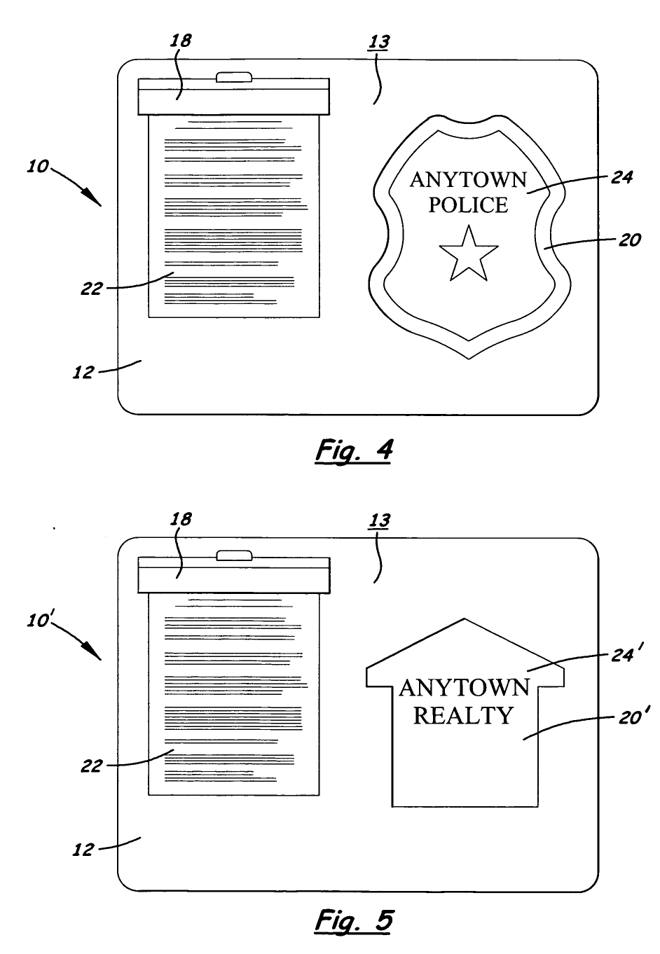

Referring now to FIGS. 4 and 5, it will be seen that recess 20 may be integrally molded or otherwise provided within upper layer 12 in any shape desired. FIG. 4 illustrates a recess in the form of a shield that might be used by a law enforcement agency. FIG. 5 illustrates a another writing mat device 10′ with a recess 20′ in the form of a house that might be used by a realtor. Decals 24, 24′ or other indicia, describing the using agency, may be placed within recess 20, 20′ if so desired.

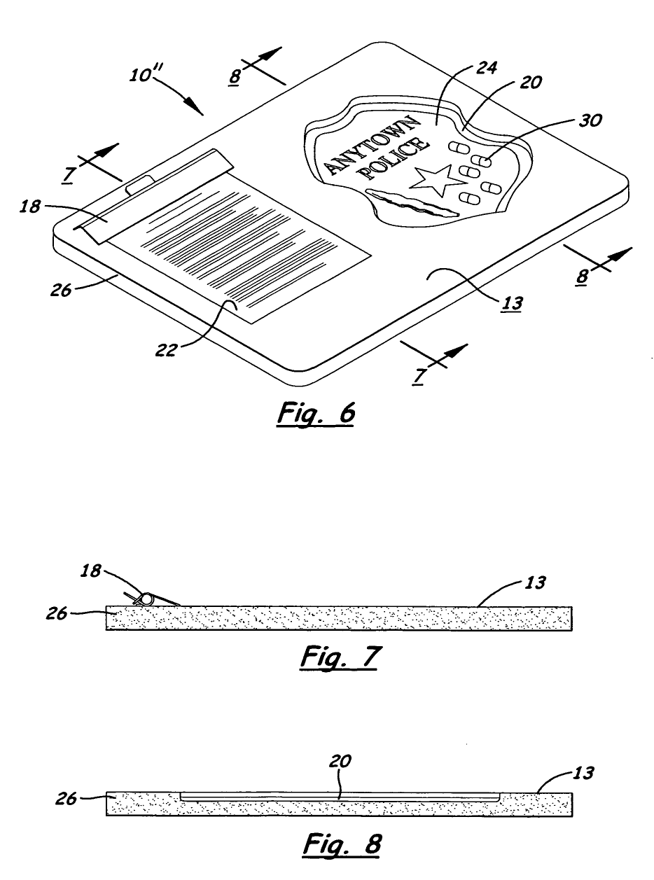

Referring now to FIGS. 6, 7 and 8, there is illustrated another embodiment, writing mat device 10″ in which upper layer 12 and lower layer 14 and adhesive 16 have been replaced by one layer 26 having at least a portion that is magnetic. This embodiment may have the same or similar features, and may be used the same, as the earlier-described embodiment.

In FIG. 3, one may notice that the recessed area (recess 20) may extend part way into the upper layer 12, but it should understood that the recess may instead be formed so that it extends all the way through the upper layer 12, and optionally also into the lower layer 14. Preferably, the recess does not extend all the way through the entire panel of the device 10, 10′, so that the retained items do not rest on the vehicle surface, and, hence, cannot damage the vehicle surface. Alternatively, the writing mat may not include any recessed area, and may not include any indicia or the indicia may be otherwise located.

The preferred panel may be made of multiple layers (including 2 or three, for example), a single layer, or a single major layer coated or covered with a thin coating (a minor layer). The preferred panel is preferably flexible, at least to the extent that the panel can match the contour of a hood or a trunk lid. The flexibility also helps the user roll or at least bend the device to fit into a storage space or container. The preferred writing mat has a thickness that is much smaller than its other dimensions (width and length); for example, the mat may be about ¼ to 1 inches thick, while being 14 inches wide and 20 inches long, in order to provide about a 10×14 inch space for paper and writing, and a 10×14 inch space for a recessed area and indicia. Various sizes and shapes of recess or recesses may be used, for example, recesses at least 3 inches wide (3-10 inches, for example) and at least 3 inches long (3-10 inches, for example) and at least ¼ inch deep (¼-1 inch, for example). Thus, one may see that the recess is not merely a hole or small indent in the panel, and the preferred recess does not normally hold any structure except for the loose items it temporarily retains; for example, the preferred recess is not merely a hole receiving a screw, pin, or other fastener or object. The items received in the recess are not attached to the panel or writing mat, but, instead, simply lie in the recess and remain there by gravity.

Alternatively, systems other than a recess or recesses may be provided for retaining loose items. For example, a raised ridge or ring, an upending wall or walls, an open or lid-covered box attached to the panel, or item clips or hooks may be used. The recess(es) are preferred, however, because of their simplicity, effectiveness, and lack of structure protruding up from the upper surface of the panel. The recess(es) do not interfere with the user's hand or otherwise get in the way; objects or paperwork may be laid across the recess(es).

Preferably, the writing mat device is substantially two-dimensional (much wider and longer than thick) and so is not a box or briefcase. The preferred writing mat device uses its generally horizontal position on a generally horizontal vehicle panel/portion to help prevent objects from rolling off of the device. By “generally horizontal” it is meant that the device and the vehicle panel/portion on which it is installed are more horizontal than vertical (thus, horizontal or less than 45 degrees from horizontal). Preferably, there are no or few moving parts, with preferably the only moving part(s) being one or more clips for retaining paper or other items.

The magnetized material used in the writing mat may be of the type known by the name “magnetic sheet” or “flexible magnet” or “magnetic strip” that is easily available from many magnet manufacturers, including Rochester Magnet of East Rochester, N.Y., or Adams Magnet Products of Chicago or New York, for example. This material typically comes in sheets 0.015-0.06 inches thick, and, therefore, the preferred embodiments will have one or more additional layers of material to form a slightly-padded writing surface, structure to which a paper holding system may be attached, and/or a thickness sufficient to provide an effective item-holding recess. The lower layer or lower surface of the panel may be made entirely of this material or, less preferably, may comprise strips or patches of this material, for example. Other magnetic material may be used but it is preferred that the magnetic material be lightweight and not have edges or protrusions tend to damage the vehicle if the writing is tossed or “thrown” down on the vehicle surface.

The invented device, in some embodiments, may consist essentially of a panel, a spring-loaded or otherwise biased paper holding member, and a recess for holding items, wherein the panel has magnetic properties and is flexible for adhering to and contouring to a generally horizontal vehicle surface. The invented device, in some embodiments, may consist only of a panel, a spring-loaded or otherwise biased paper holding member, and a recess for holding items, wherein the panel has magnetic properties and is flexible for adhering to and contouring to a generally horizontal vehicle surface. Alternatively, the device may include other elements, such as a flap (not shown) for folding over the papers or the items, for example.

Although this invention has been described above with reference to particular means, materials, and embodiments, it is to be understood that the invention is not limited to these disclosed particulars, but extends instead to all equivalents within the broad scope of the following claims.

I claim:

1. A method for providing a writing space on a vehicle, said method comprising:
providing a writing mat having at least a portion that is magnetic, wherein said writing mat has a paper holding system connected to a top surface of the writing mat;
placing said writing mat on a generally horizontal exterior vehicle surface having metallic properties whereby the writing mat magnetically adheres to said exterior vehicle surface; and
holding at least one sheet of paper within said paper holding system; and
writing or marking said at least one paper.

2. A method as in claim 1, wherein said writing mat comprises a recess in its upper surface, and the method further comprises retaining loose items on said writing mat by placing them in said recess.

3. A method as in claim 1, wherein said paper holding system comprises a clip attached to the upper surface of the writing mat.

4. A method as in claim 1, wherein said writing mat is flexible so that it curves to adhere to the contour of the vehicle surface upon which it is placed.

5. A method as in claim 1, further comprising using said writing mat on a police car.

6. A method as in claim 1, further comprising using said writing mat on a police car, and said writing or marking said at least one paper comprises writing a traffic ticket or warning.

7. A method as in claim 1, wherein said writing mat comprises a recess in its upper surface, and the method further comprises retaining loose items on said writing mat by placing them in said recess, and wherein said loose items are items confiscated in a traffic stop by a law enforcement officer.

8. A method as in claim 1, further comprising leaving the writing mat on the vehicle surface and driving away wherein the writing mat stays in place on the vehicle surface for subsequent use at a time when the user stops the vehicle and exits the vehicle again.

9. A writing system for people working near a vehicle, the system comprising:
a writing mat comprising a panel having at least a portion that is magnetic;
a clip on an upper surface of the panel adapted to hold at least one paper on said upper surface for access for writing or marking the at least one paper;
a recess in the upper surface of the mat that is open and empty so that it is available to receive and hold a loose item.

10. A writing system as in claim 9, wherein said panel comprises a layer of flexible magnetic material.

11. A writing system as in claim 9, wherein said writing mat is entirely flexible except for said clip.

12. A writing system as in claim 9, wherein said panel comprises a layer of flexible magnetic material and a polymeric writing surface attached to a top surface of the flexible magnetic material.

13. A writing system for people working near a vehicle, the system comprising:
a vehicle having a generally horizontal metallic vehicle surface;
a writing mat comprising a panel having at least a portion that is magnetic and said writing mat removably magnetically installed on said metallic vehicle surface;
a clip on an upper surface of the panel adapted to hold at least one paper on said upper surface for access for writing or marking the at least one paper;
a recess in the upper surface of the mat that is open and empty so that it is available to receive and hold a loose item.

14. A writing system as in claim 13, wherein said vehicle surface is an engine compartment hood.

15. A writing system as in claim 13, wherein said vehicle surface is a trunk lid.

16. A writing system as in claim 13, wherein said writing mat has a lower surface that is continuously magnetic.

17. A writing system as in claim 13, wherein said writing mat has magnetic strips on its lower side.
